(19) United States
(12) Patent Application Publication
(10) Pub. No.: US 2025/0232310 A1
(43) Pub. Date: Jul. 17, 2025

(54) CONTROLS FOR VULNERABLE ADULTS

(71) Applicant: Wells Fargo Bank, N.A., San Francisco, CA (US)

(72) Inventors: Mosiah Monroe-Estes, Vallejo, CA (US); Alan W. Hecht, San Francisco, CA (US)

(21) Appl. No.: 19/001,129

(22) Filed: Dec. 24, 2024

Related U.S. Application Data
(60) Provisional application No. 63/621,301, filed on Jan. 16, 2024.

(51) Int. Cl. G06Q 20/40; G06F 9/54

(52) U.S. Cl. CPC G06Q 20/405; G06F 9/54; G06Q 20/4016

(57) ABSTRACT

An example computer system for controlling finances for a vulnerable adult can include: one or more processors; and non-transitory computer-readable storage media encoding instructions which, when executed by the one or more processors, causes the computer system to generate: a people module programmed to limit communications between the vulnerable adult and untrusted individuals; a payments module programmed to limit transactions with third parties by the vulnerable adult; and a reporting module programmed to provide a history of the communications and the transactions.

### BACKGROUND

Adults typically control their own finances. However, there are situations in which vulnerable adults could make poor financial decisions. For instance, older adults can be susceptible to fraud that takes advantage of their trusting nature or diminished capacities. This can result in the loss of control over finances for these individuals.

### SUMMARY

This disclosure is directed to financial controls for vulnerable adults.

In one aspect, an example computer system for controlling finances for a vulnerable adult can include: one or more processors; and non-transitory computer-readable storage media encoding instructions which, when executed by the one or more processors, causes the computer system to generate: a people module programmed to limit communications between the vulnerable adult and untrusted individuals; a payments module programmed to limit transactions with third parties by the vulnerable adult; and a reporting module programmed to provide a history of the communications and the transactions.

In another aspect, an example method of calculating a fraud score for financial transactions of a vulnerable adult can include: analyzing transaction data using artificial intelligence to calculate the fraud score based on recipient information; routing transactions for approval based on the fraud score; and generating alerts when the fraud score meets or exceeds defined thresholds.

### DESCRIPTION OF THE DRAWINGS

FIG. 1 shows an example system for controlling finances of a vulnerable adult.

FIG. 2 shows example logical components of a vulnerable adult device of the system of FIG. 1.

FIG. 3 shows an example flowchart of the approval workflow for transactions as implemented by the system of FIG. 1.

FIG. 4 shows an example graphical user interface generated by the vulnerable adult device of the system of FIG. 2.

FIG. 5 shows example physical components of the vulnerable adult device of FIG. 2.

### DETAILED DESCRIPTION

This disclosure is directed to financial controls for vulnerable adults.

In examples provided herein, financial accounts are created for the benefit of a vulnerable adult, such as an aging parent or other adult with diminished capacities that impact the adult's ability to make financial decisions. These financial accounts can have controls set by overseers, such as adult children of the aging parent. The account controls can combine one or more of a set of rules, approvals, fraud identification tools, and the like. The account controls can be applied to many types of messages and transactions associated with the accounts (e.g., credit, debit, Zelle, etc.). These controls can thereby help to reduce fraud.

In some examples, the accounts are set up in a manner where the overseer (e.g., adult child) is the owner of the account, and the vulnerable adult is an authorized user subject to the example controls described herein. However, other configurations are possible.

While the terms “adult” and “child” are used herein, these terms are used as examples. The adult can be anyone who exhibits diminished capacities. This will typically be an individual who is over the age of 18, although the examples are not so limited. The overseer can be an actual adult child of the adult, a guardian of the adult, other relative of the adult, or adult otherwise given the role of overseeing the adult. Many configurations are possible, and the terms “adult” and “child” should not be construed in a limiting way.

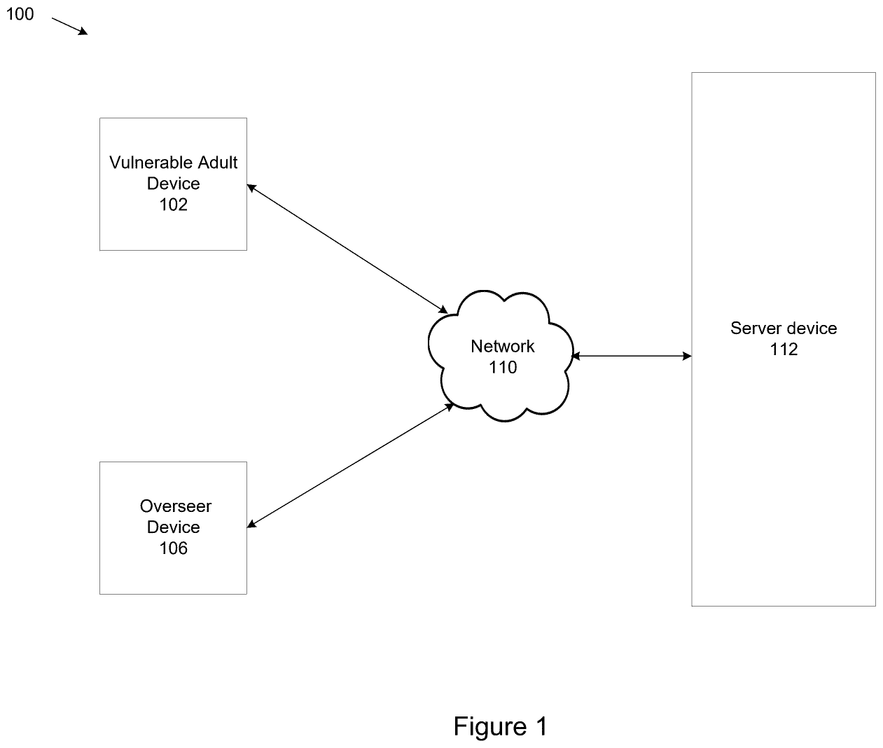

FIG. 1 schematically shows aspects of one example system 100 that facilitates the software applications that provide for control of the finances of the vulnerable adult. The system 100 includes a vulnerable adult device 102, an overseer device 106, and a server device 112.

In these examples, the vulnerable adult device 102 is a computing device used by the adult with diminished capacities. The overseer device 106 is a computing device that is used by the individual or individuals who are overseeing the finances for the adult, such as the adult child. The vulnerable adult device 102 and the overseer device 106 can be the same device in some instances.

The server device 112 is a computing device that is typically managed by an entity associated with the vulnerable adult and/or overseer. In one non-limiting example, the entity is a financial institution that provides financial services to customers, including the vulnerable adult and/or the overseer. However, the concepts described herein are equally applicable to other types of entities.

Each of the devices 102, 106 and 112 may be implemented as one or more computing devices with at least one processor and memory. Example computing devices include a smartphone, a mobile computer, a desktop computer, a server computer, or other computing device or devices such as a server farm or cloud computing used to generate or receive data.

In this example, the vulnerable adult device 102 can be programmed to include one or more software applications in addition to other typical smartphone functionality. These software applications allow the adult to have limited access to various online banking activities, such as accessing and checking balances, transferring money, making payments, etc. In addition, the software applications can be used to control certain functionality of the vulnerable adult device 102, as described further below.

In the examples shown, the overseer device 106 can be programmed to control aspects of the vulnerable adult device 102 as the vulnerable adult device 102 communicates with the server device 112 to perform financial transactions. In some examples, the overseer has full access to the accounts created for the vulnerable adult and various controls associated with those accounts, as described herein. For instance, the vulnerable adult device 102 and the overseer device 106 can communicate with the server device 112 through a network 110 to effectuate financial transactions, as described herein. While only two client devices are shown in the example of the system 100, in reality there can be hundreds or thousands of devices that communicate with the server device 112.

The server device 112 can be programmed to deliver functionality to the vulnerable adult device 102 and the overseer device 106, such as providing payment services like, without limitation, card, Zelle, wallet, ACH, etc. For example, in one embodiment, the server device 112 is one or more computers (typically a server farm or part of a cloud computing environment) that facilitates the functionality described herein.

The examples provided herein solve multiple technical problems. For instance, the examples provide a more efficient way to manage the technical problems associated with fraud, particularly those that are effectuated using today's advanced technologies on the Internet. These examples include the practical application of rules and artificial intelligence that enhance a computer's ability to identify and mitigate these fraudulent activities. Many other technical advantages are provided.

More specifically, the disclosure can provide technological improvements in computer security and fraud prevention through the implementation of artificial intelligence to calculate fraud scores for transactions by analyzing multiple technical data points including IP addresses, contact information, and known fraud patterns. This represents significantly more than simply applying generic computer components to make decisions. The technology can be integrated with third-party software applications through Application Programming Interfaces to apply fraud controls across multiple platforms like Facebook Marketplace, Amazon, and other digital marketplaces. This technical integration enables comprehensive protection across various digital channels, rather than basic transaction blocking.

The disclosure can also provide a practical application through automated workflow routing based on sophisticated rule sets that consider multiple technical factors. Such factors can include, without limitation, transaction velocity monitoring across digital payment channels, integration with recurring payment systems, fraud score calculation, dynamic approval routing based on transaction parameters, and/or an automated escalation processes.

In some examples, the disclosure improves computer network security by implementing technical controls that monitor and control message delivery across multiple digital communication channels. This can include an analysis of network traffic patterns for suspicious activity, as well an integration of fraud detection across multiple payment mechanisms (cards, ACH, digital payments). Further, the disclosure can provide secure approval workflows with multiple authentication factors and/or create audit trails of system activities.

These examples provide specific technical improvements in how computers detect and prevent fraud through artificial intelligence, Application Programing Interface integrations, and sophisticated workflow automation. The disclosure addresses uniquely technical problems related to digital fraud by implementing novel technical solutions that go well beyond simply applying generic computer components to automate manual processes. The sophisticated integration of artificial intelligence, Application Programing Interfaces, and automated workflows represents significantly more than abstract mental processes.

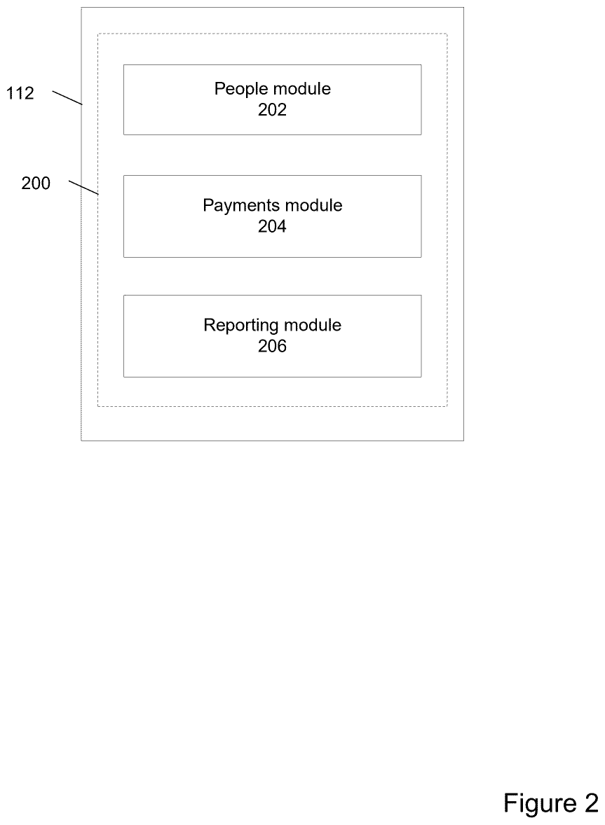

Referring now to FIG. 2, additional details are shown for the server device 112. The server device 112 can include various logical modules. These modules are created when the processor of the server device 112 executes instructions stored on the storage device to provide the functionality described herein.

More specifically, the server device 112 includes various software applications that are executed by the processor of the server device 112 according to the instructions stored on the storage media of the server device 112.

In some examples, the server device 112 executes a software application 200 that includes a people module 202, a payments module 204, and a reporting module 206. This is only an example, and the functionality associated with the software application 200 can be spread across multiple applications and/or be provided by other computing devices, such as the vulnerable adult device 102 and/or the overseer device 106.

In the example provided, the people module 202 is programmed to control the individuals who are allowed to contact and/or interact with the vulnerable adult device 102. This can include both managing the delivery of messages from untrusted individuals and payments to untrusted individuals. By managing these activities, the likelihood for fraud, such as phishing and other scams, can be minimized.

In this example, the people module 202 controls the messages (e-mails, calls, texts, etc.) that are allowed to be delivered to the vulnerable adult device 102. For instance, the people module 202 can be programmed to only allow messages from “trusted” contacts to be delivered. Examples of trusted contacts include family and friends of the vulnerable adult. It is assumed that communications from individuals other than the trusted contacts represent a greater risk for fraud and can therefore be blocked or require approval before being delivered to the vulnerable adult in at least some instances.

For instance, the server device 112 can be programmed to control which messages are delivered to the vulnerable adult device 102. Examples of such messages include, without limitation, texts, emails, phone callers, messaging screen names, etc. In some instances, messages from trusted contacts are automatically delivered, while those from untrusted individuals must be approved by the overseer on the overseer device 106 before delivery.

When a message is sent to the vulnerable adult device 102 from an individual who is not trusted, the server device 112 can contact one or more overseers for approval before the message is delivered. An escalation process can be used if one overseer is unavailable or otherwise unable to act on the request. When approved, the message is delivered to the vulnerable adult device 102. If not approved, the message is not delivered. This can include quarantining and/or deleting messages that are not approved.

An example table defining a trusted contact follows. This definition can include such information as the trusted contact's name, telephone number, and email address. When the trusted contact is also an overseer, the definition can also include information associated with how the overseer can approve messages and wants to be alerted.

| | | | Approval | Alert |
|---|---|---|---|---|
| Name | Phone | Email | Preference | Preference |
| John | 999-999-9999 | John.doe@gmail.com | text, email, | text, |
| Doe | | | phone | email, |
| | | | call, etc. | message |

For instance, an unknown individual could send a message to the vulnerable adult for payment of a bill. The server device 112 receives the message requesting the payment and, according to a set of rules, contacts one or more overseers for approval before delivering the email to the vulnerable adult. For instance, an email can be sent to the overseer “John Doe” at the overseer device 106 with details about the message from the unknown individual and requesting approval before delivery. If John Doe approves the message, the message is then delivered to the vulnerable adult device 102. If not, the message is quarantined or deleted. In other examples, the alert is simply sent to the overseer without requiring approval so that the overseer knows that the messaging is occurring. This functionality can be integrated into various applications that are resident on the vulnerable adult device 102, such as Gmail, Facebook, iMessage, etc. Many configurations are possible.

There could be multiple rules requiring various approvals depending on the type of message. For instance, for messages requesting a financial transaction, the vulnerable adult device 102 could require multiple approvals before the message is delivered and/or the vulnerable adult device 102 can be used to make a payment.

For instance, the server device 112 can define an approval workflow that is required before a message is delivered. The workflow can be based upon such information as who has made the request, the timing of the request, and/or the amount of the request. In some examples, the workflow can be defined based upon input from one or more of the overseers. Examples of such workflows are provided in one or more of the tables below.

For instance, requests for smaller amounts of money (e.g., less than $100) can be approved automatically or by only a single overseer. Requests for larger amounts of money may require multiple approvals to proceed. This can protect against fraud that may be perpetrated by a trusted contact of the vulnerable adult. Many configurations are possible.

Further, the approval process can be predicated on the qualifications associated with the trusted contacts and/or overseers. For instance, trusted contacts and/or overseers can be required to undergo qualification requirements before approvals can be performed, such as background checks (e.g., criminal history), qualification reviews (e.g., must be 18 or older), etc. Or, depending on the status of the overseer, the server device 112 can require approval from multiple overseer devices 106 before a message is delivered. For instance, when one of the overseers is younger (e.g., 18-20 years old), the vulnerable adult device 102 may require approval from multiple overseers before a message is delivered.

Configuration of who can approve certain transactions can be defined by one or more of the overseers. For instance, each overseer can be configured to have credentials for approval or denial of additional overseers and/or change other configurations, such as the payment workflows described below. An example table defining this configuration follows. In this example, overseer “name1” can both change the overseer names and other configurations, while overseer “name2” can only change other configurations (not change overseers). Many configurations are possible.

| Required | | |
|---|---|---|
| approver to | | |
| config names | Can add / change approval names y/n | other config |
| name1 | Y | Y |
| name2 | N | Y |

The example payments module 204 of the server device 112 is programmed to control any transactions made by the vulnerable adult using the vulnerable adult device 102. Such aspects as who is being paid, the amount, what is being purchased, etc. can be analyzed by the payments module 204 before the transaction is approved.

For instance, the payments module 204 can be programmed to use artificial intelligence to scrutinize each transaction and develop a fraud score, which estimates whether the payment is legitimate. Based upon that fraud score, the payments module 204 can generate one or more alerts and/or withhold payment pending approval by an overseer, as described further below.

In some examples, the payments module 204 is programmed to limit transaction based upon a payment type. For instance, payment by the vulnerable adult device 102 using one or more payment mechanisms (e.g., card, Zelle, ACH, etc.) for gambling can require multiple approvals by overseers before the transaction is allowed.

Further, the method of payment can also be managed by the payments module 204. For instance, payments through credit cards can be managed differently from payments through the Automated Clearing House (ACH) due to the inherent differences in the payment types. An example table below defines how the payments module 204 can be programmed to handle different payment types. The table also defines what approval is needed (e.g., single or multiple overseers) and who is alerted for such a transaction (e.g., all overseers or just a primary overseer). Alerts can be defined based upon group type (e.g., all overseers), a subset of a group, and/or individuals (e.g., by name). The groups for alerts can be defined dynamically.

| | Maximum | | |
|---|---|---|---|
| | transaction | Approval | |
| Payment type | amount | rules | Alert |
| wire | $1,000 | 2 overseers | All overseers |
| debit card | $200 | 1 overseers | Primary overseer |
| credit card | $300 | 1 overseers | Primary overseer |
| ACH | $50 | 2 overseers | Primary overseer |
| Cash (ATM & Branch) | $50 | 1 overseers | Primary overseer |

Various approval workflows can be applied to each type of transaction. In the example table below, workflows are defined for various transactions, such as rent and gambling. A default workflow is also defined for other types of transactions.

| | | Approvals |
|---|---|---|
| Approval Name | Approval Type | required |
| Default | single | Text |
| Rent | dual | name1, name2 |
| Rent | multi with rule | name1, name2 |
| gambling yearly | multi with rule | name1, name2 |
| | (rule = specific casino) | |
| gambling daily | dual | name1, name2 |

For instance, for the approval for yearly gambling transactions, the workflow requires multiple approvals (e.g., two overseers) and also defines a rule specifying that the transactions can only be done at a specific casino. These are examples only, and it is possible to define any type of rule desired.

The payments module 204 can be programmed to recognize certain expected, recurring transaction so that approval by an overseer is not required or a lesser approval requirement is needed (e.g., a single overseer versus multiple overseers). Examples of such recurring payment (see table below) include rent, utilities (e.g., garbage, electricity, cable), medications, etc.

The amount of each of these transactions can be scrutinized by the payments module 204 so that unexpected increases in recurring payments can require overseer approval. However, in some examples, the payments module 204 can be programmed to adjust for variation in these types of transaction, such as for inflation or seasonal changes. For instance, the payments module 204 can be programmed to allow for some increase in the costs of medications over time as inflation increases. Similarly, the payments module 204 can be programmed to allow for an increase in the gas bill during the winter months when heating is needed.

An example table below illustrates how the payments module 204 can be programmed to address such recurring payments. Logic can include defining how often the payments are made, the average cost, limits on costs per time period, etc.

| | Daily | | Monthly | Yearly | Calendar | Payment | |
|---|---|---|---|---|---|---|---|
| Expense | limit | Weekly | limit | limit | average | average | Velocity |
| Rent | — | — | $700 | $9,000 | $8,500 | $725 | Count per |
| | | | | | | | day/week/ |
| | | | | | | | month/year |
| Gas | — | — | $75 | $950 | $900 | $70 | |
| Electric | — | — | $75 | $950 | $900 | $70 | |
| Garbage | — | $5 | — | $300 | $225 | $8 | |
| Prescriptions | — | $50 | $200 | $2,500 | $2,450 | $25 | |

The payments module 204 can be programmed to monitor the velocity of payments and provide alerts when there is an unusual number of transactions in a given period. See table above. For instance, the payments module 204 can be programmed to determine when there are an abnormal number of payments to a particular individual or vendor and possibly limit further payments until approval is given by an overseer. For instance, when a large number of transactions occur at a grocery store in a short amount of time, the payments module 204 can be programmed to limit further transactions until an overseer is alerted for approval.

In another example, the payments module 204 can provide even more definition on recurring payments, such as when such payments are expected, the frequency of the payments, etc. In the table below, the payments module 204 is programmed to allow for such variables to be defined for recurring payments.

| | | | | Day of |
|---|---|---|---|---|
| Payment Category | frequency | Days of month | Month | Week |
| Rent | monthly | 1, 2 | Monthly | — |
| Electricity | monthly | 20, 21, 22 | Monthly | — |
| Insurance | yearly | — | January | — |
| Car | monthly | 2, 4 | monthly | — |
| Gym | weekly | — | monthly | Monday |

In addition to recurring payments, the payments module 204 can be programmed to provide preauthorization for unique expense, such as those for planned vacations, gifts, etc. In such a scenario, the overseer(s) can provide preauthorization for these transactions based upon the transaction type, amount, etc. This allows the payments module 204 to automatically authorize the transactions without requiring approval or requiring a lesser approval.

For instance, when the vulnerable adult has planned a trip to Yellowstone National Park, the payments module 204 can be programmed to automatically authorize payment associated with that trip, such as expenses for hotels, meals, etc. tied to a location in or near Yellowstone so that the transactions associated with the vulnerable adult are not declined on the trip.

The payments module 204 can allow specifics to be defined for each unique event, such as a dollar amount, date, location, recipient, merchant, etc. An example table defining such specifics follows.

| Event | Date range | Categories | Location |
|---|---|---|---|
| Yellowstone | Jan. 2, 2024-Jan. 15, 2024 | Gas, food | Idaho |
| trip | | | |
| Gifts for | Variable | Toys, | Iowa |
| grandkids | | electronics | |

In addition to defining unique expenses, the payments module 204 can be programmed to limit or restrict payments for certain goods and services. Such limits can include budgeting for items like gambling, cigarettes, alcohol, cryptocurrencies, cash withdrawals, etc. In the table that follows, example limits for such goods and services are defined by the payments module 204.

| Excluded | Daily limit | Weekly | Monthly | Yearly |
|---|---|---|---|---|
| Bar | $0 | $0 | $0 | $0 |
| Gambling | $10 | $25 | $50 | $700 |

In this example, purchases in bars are never allowed, while gambling is allowed within certain limits based upon the day, week, month, and year. In addition, time limits can be established by the payments module 204. For instance, transactions can be limited based upon the time of day or day of the week. For instance, the following table allows the payments module 204 to limit purchases for alcohol and food to certain times of the day.

| Payment Category | Exclusion Times |
|---|---|
| Alcohol | Midnight-4AM |
| Eating | Midnight-6AM |

Such limits can be superseded by the payments module 204 based upon unique circumstances, such as the travel exclusions for Yellowstone described in the example above.

The payments module 204 can be programmed to be integrated into other software applications on the server device 112 so that limits apply within those software applications. For instance, the payments module 204 can be programmed to be integrated into such applications as Facebook Marketplace, Amazon, BestBuy, etc. so that limits on messaging and transactions apply for those applications on the server device 112. This can be accomplished through direct integration with these applications, through Application Programming Interfaces, etc. The payments module 204 can further be programmed to communicate with these other applications to report when a fraud situation is identified and/or to receive fraud information from the applications. Many configurations are possible.

The example payments module 204 is also programmed to manage the identification of fraud and report fraud as appropriate. For instance, the payments module 204 can be configured to analyze data and determine when the vulnerable adult may be exposed to a fraud. This can be done, for instance, using artificial intelligence.

For instance, when a software application (e.g., Zelle, card, ACH, etc.) on the vulnerable adult device 102 is used to communicate with certain individuals or initiates one or more transactions outside of the ordinary, the overseer can be notified by the payments module 204. An example of such a notification is: “Your mother is trying to purchase a warranty for her computer for $500, is there a potential that your mom is getting scammed?” Such a warning can be presented as a text message, toast notification, etc. on the overseer device 106.

The overseer can review the notification on the overseer device 106 (or an application running thereon) and respond in certain situations. For instance, the notification can include controls that allow the overseer to approve the transaction or indicate the transaction is fraudulent through the overseer device 106 (or an application running thereon). If the overseer believes it is fraudulent, the overseer device 106 can automatically contact the financial institution to hold the transaction and/or contact the vulnerable adult on the vulnerable adult device 102 or other device.

When the vulnerable adult device 102 is notified, the vulnerable adult can request reassessment by overseer(s) and add context. For instance, the vulnerable adult can select or otherwise input a reason for the transaction (e.g., “I am at the grocery store and I need cold medicine.”), which is communicated to the overseer on the overseer device 106. The overseer can thereupon make a more educated decision on whether to allow the transaction. The approval can be escalated to multiple overseers depending on factors like amount, purchase type, etc.

In some instances, the payments module 204 is programmed to examine the data surrounding a communication or transaction and calculate the fraud score associated therewith. The fraud score can be calculated by artificial intelligence based upon such information as the name of the requester/payee, contact information (e.g., phone number or email address), IP address (when purchasing a good or service online), etc.

The artificial intelligence system analyzes multiple data points surrounding each transaction or communication to calculate a comprehensive fraud score that estimates the likelihood of fraudulent activity. This score helps determine whether transactions should be automatically approved, require additional oversight, or be blocked.

Such artificial intelligence can include one or more of: machine learning models having supervised learning algorithms trained on historical transaction data to classify potentially fraudulent activities. The models can be used to analyze patterns across payment types, amounts, and frequencies to identify suspicious transactions. This can be particularly useful for evaluating transaction velocity and detecting unusual patterns in recurring payments.

The artificial intelligence can also employ Natural Language Processing (NLP), which is used to analyze text content of messages and communications for common fraud indicators. The NLP can examine context information provided by vulnerable adults explaining transactions and evaluate similarity between current messages and known fraudulent communication patterns.

The artificial intelligence can also use neural networks to process multiple data points simultaneously to calculate comprehensive fraud scores. Such neural networks can learn and adapt to new fraud patterns over time, as well as integrate data from multiple sources including third-party applications through Application Programming Interfaces.

Other artificial intelligence could also be implemented, such as pattern recognition networks, anomaly detection systems, and/or rule-based system. The artificial intelligence as implemented by the payments module 204 can thereby calculate fraud scores based on multiple risk factors, route transactions for appropriate approval workflows, generate alerts for suspicious activities, and/or maintain audit trails of decisions.

Example technical components that the artificial intelligence of the payments module 204 evaluates can include the name and identity information of the requester/payee, contact details including phone numbers and email addresses, IP addresses for online transactions, transaction patterns and velocity, and/or known fraud indicators from the system's scammer database. In some examples, the payments module 204 is programmed to maintain detailed data structures of known fraudulent activities, such as in a database. These details can include: websites associated with scams, phone numbers used in fraud attempts, email addresses linked to suspicious activity, IP addresses connected to fraudulent transactions, and/or names and descriptions of known scammers.

When calculating the fraud score, the artificial intelligence of the payments module 204 can examine transaction velocity to identify unusual patterns, such as: abnormal numbers of transactions in a short timeframe; multiple payments to the same recipient; unusual transaction amounts compared to historical patterns; and/or deviations from expected recurring payment behaviors. The artificial intelligence can thereupon calculate a fraud score considering the velocity, along with aspects like the transaction type and payment method, with different risk profiles for different transactions (e.g., credit card transactions versus ACH transfers versus digital payment services like Zelle).

The artificial intelligence of the payments module 204 can be integrated with third-party applications through APIs to gather additional fraud detection data and share identified fraud patterns across platforms, creating a more comprehensive fraud detection network.

An example of a table with information identifying known frauds is provided below.

| Known | Known | | | | | |
|---|---|---|---|---|---|---|
| Scammer | Scammer | | Phone | | | Scammer |
| Tag | description | Web sites | Numbers | Email addresses | IP addresses | names |
| Ozone | Ozone does | www.puppynow.com | 999-999-9999 | puppynow@puppynow.com | 123.23.123.22 | John |
| | puppy scams | | | | | Ozone |
| | and is an | | | | | |
| | imposter | | | | | |

The fraud score can be used to estimate a likelihood that the vulnerable adult is being defrauded. When the fraud score meets or exceeds a threshold, alerts can be provided to the overseer device 106 and/or the message or transaction can be held or blocked.

Finally, the reporting module 206 can be programmed to provide a history of the various actions performed by the software application 200. This can include a list of outstanding approvals, a history of approved/rejected messages and transactions, alerts generated, configuration changes, any transactions or updates, etc. This functions as an audit trail and can be used to determine trends associated with fraudulent activities and/or the vulnerable adult.

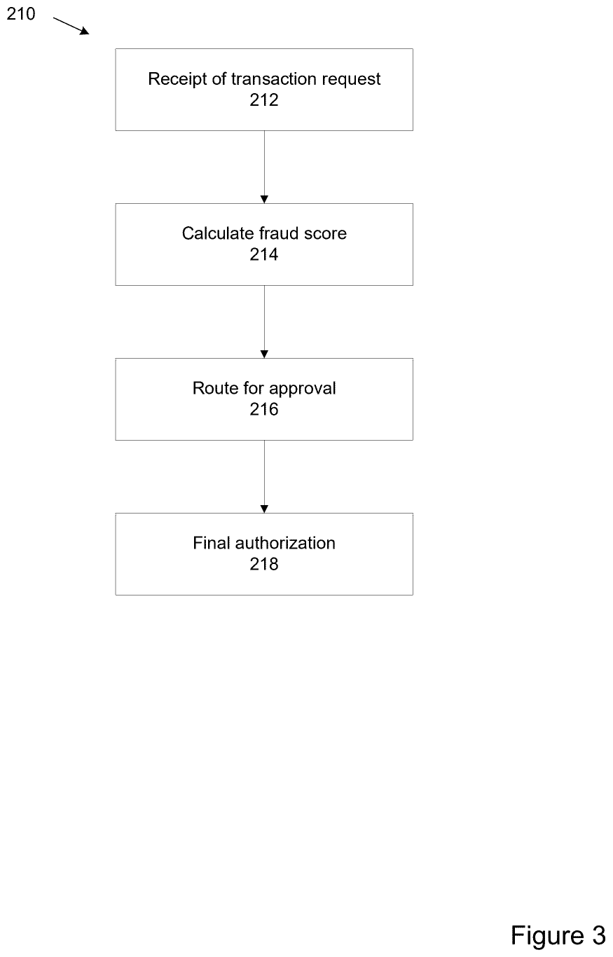

Referring now to FIG. 3, an example method 300 is shown for handling transactions and communications. The method 300 multiple operations performed by the server device 112 to evaluate and route requests for approval.

At operation 212, the server device 112 receives a transaction or communication request. The request can be initiated through various payment mechanisms (e.g., card, Zelle, ACH) or communication channels (e.g., texts, emails, phone calls) directed to the vulnerable adult device.

At operation 214, the server device 112 calculates a fraud score for the request using artificial intelligence. The fraud score is determined by analyzing data such as the requester/payee information, contact details, IP addresses for online transactions, and comparing against known fraud patterns. The fraud score estimates the likelihood that the vulnerable adult is being defrauded.

At operation 216, the server device 112 routes the request for appropriate approvals based on multiple factors. Such factors can vary as described herein. For instance, the factors can include one or more of:
a type of transaction or communication;
an amount involved for financial transactions;
a calculated fraud score;
whether the request is from a trusted contact; and/or
other applicable rules defined by overseers.
   For example, requests for smaller amounts may require only single overseer approval, while larger amounts require multiple approvals. Similarly, messages from untrusted contacts require overseer review before delivery.

At operation 218, the server device 112 makes a final authorization decision based on the approval workflow results. For approved requests, financial transactions can be processed through the appropriate payment mechanism. In such a scenario, communications are delivered to the vulnerable adult device and notifications are sent to relevant overseers.

For denied requests at operation 218, transactions can be blocked, and messages are quarantined or deleted. The vulnerable adult and overseers can be notified as appropriate.

The example method 300 provides multiple layers of protection through automated fraud detection and configurable human oversight to help prevent financial exploitation of vulnerable adults.

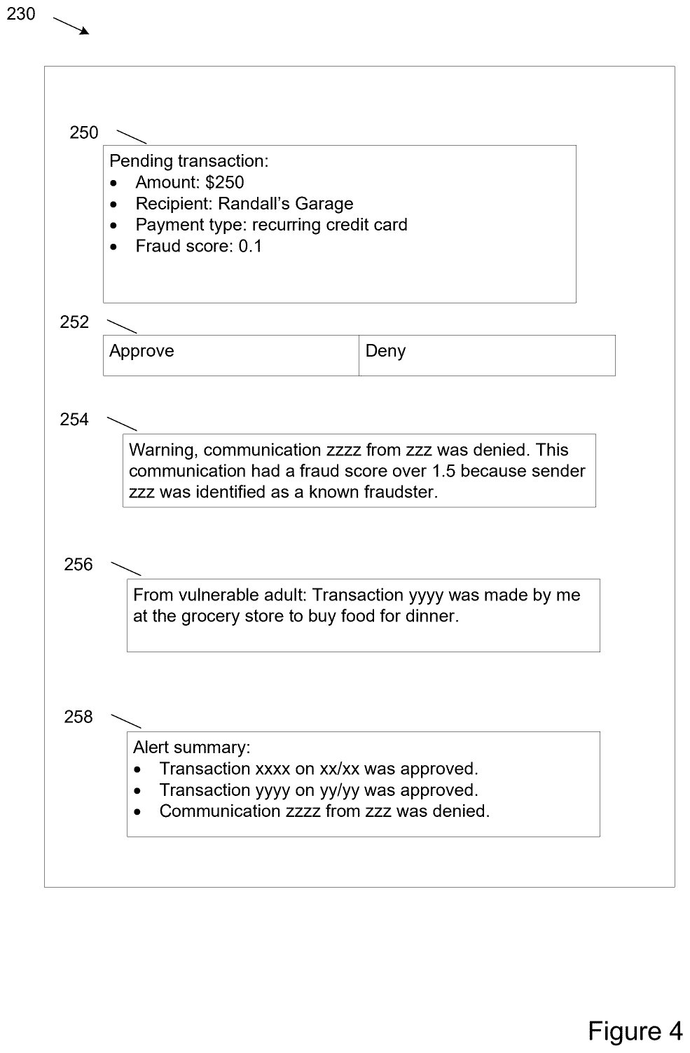

Referring now to FIG. 4, an example user interface 230 is shown for overseers to review and manage transactions and communications for vulnerable adults. The interface 230 provides controls for approving requests and viewing relevant transaction details.

The interface 230 includes a request details section 250 that displays key information about the pending transaction or communication. For financial transactions, this includes the amount, recipient, payment type, and fraud score calculated by the artificial intelligence system. For communications, this shows the sender's information and message content.

An approval controls section 252 of the interface 230 provides buttons or other interface control elements allowing the overseer to approve or deny the request. For instances, the buttons of the approval controls section 252 can include an “Approve” button to approve the transaction and a “Deny” button to disapprove the transaction. When multiple approvers are required based on the workflow rules, the interface 230 indicates how many additional approvals are needed.

The interface 230 can also include an alert notification area 254 that prominently displays potential fraud warnings generated by the system 100. For example, when a transaction matches known fraud patterns or involves suspicious payment requests, relevant warning messages are shown to help the overseer make an informed decision.

A context input section 256 surfaces feedback from the vulnerable adult and/or overseers. For instance, context input section 256 can provide feedback from the vulnerable adult to provide indicate additional information about their request when it is initially flagged or denied. This enables the vulnerable adult to explain legitimate transactions, such as “I am at the grocery store and need cold medicine,” which helps overseers better evaluate the request.

The interface 230 also includes a transaction history view 258 showing recent approved and denied requests, providing an audit trail of decisions. This history can be filtered by transaction type, date range, and approval status to help overseers identify patterns and monitor activity.

The elements of the interface 230 are designed to work across multiple device types, including smartphones, tablets, and desktop computers, ensuring overseers can review and respond to requests through the overseer device regardless of their location.

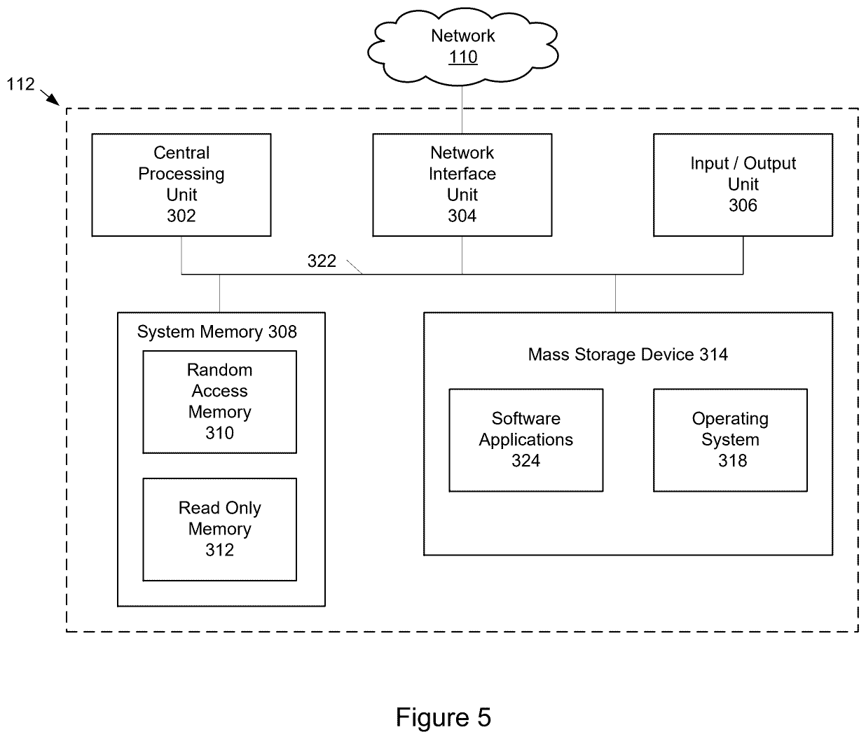

As illustrated in the embodiment of FIG. 5, the example server device 112 can include at least one central processing unit (“CPU”) 302, a system memory 308, and a system bus 322 that couples the system memory 308 to the CPU 302. The system memory 308 includes a random access memory (“RAM”) 310 and a read-only memory (“ROM”) 312. A basic input/output system containing the basic routines that help transfer information between elements within the vulnerable adult device 102, such as during startup, is stored in the ROM 312. The vulnerable adult device 102 further includes a mass storage device 314. The mass storage device 314 can store software instructions and data. A central processing unit, system memory, and mass storage device similar to that in FIG. 3 are also included in other computing devices disclosed herein (e.g., the devices 106, 112).

The mass storage device 314 is connected to the CPU 302 through a mass storage controller (not shown) connected to the system bus 322. The mass storage device 314 and its associated computer-readable data storage media provide non-volatile, non-transitory storage for the vulnerable adult device 102. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the vulnerable adult device 102.

According to various embodiments of the invention, the vulnerable adult device 102 may operate in a networked environment using logical connections to remote network devices through network 110, such as a wireless network, the Internet, nearfield communication (NFC), or another type of network. The vulnerable adult device 102 may connect to network 110 through a network interface unit 304 connected to the system bus 322. It should be appreciated that the network interface unit 304 may also be utilized to connect to other types of networks and remote computing systems. The vulnerable adult device 102 also includes an input/output controller 306 for receiving and processing input from a number of other devices, including a touch user interface display screen or another type of input device, such as interfaces for receiving gestures, eye movements, interpreting brain waves, etc. Similarly, the input/output controller 306 may provide output to a touch user interface display screen or other output devices.

As mentioned briefly above, the mass storage device 314 and the RAM 310 of the vulnerable adult device 102 can store software instructions and data. The software instructions include an operating system 318 suitable for controlling the operation of the vulnerable adult device 102. The mass storage device 314 and/or the RAM 310 also store software instructions and applications 324, that when executed by the CPU 302, causes the vulnerable adult device 102 to provide the functionality of the vulnerable adult device 102 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for controlling finances for a vulnerable adult, comprising:
one or more processors; and
non-transitory computer-readable storage media encoding instructions which, when executed by the one or more processors, causes the computer system to generate:
a people module programmed to limit communications between the vulnerable adult and untrusted individuals;
a payments module programmed to limit transactions with third parties by the vulnerable adult; and
a reporting module programmed to provide a history of the communications and the transactions.

2. The computer system of claim 1, wherein the payments module is further programmed to interface with software on a computing device accessed by the vulnerable adult to control payment vehicles.

3. The computer system of claim 1, wherein the people module is further programmed to:
maintain a database of trusted contacts; and
require approval from one or more overseers before delivering messages from untrusted individuals to the vulnerable adult.

4. The computer system of claim 1, wherein the payments module is further programmed to:
calculate a fraud score using artificial intelligence based on transaction data including recipient information, contact details, and IP addresses; and
route the transactions for approval based on the fraud score.

5. The computer system of claim 1, wherein the payments module is further programmed to:
identify recurring payment transactions;
monitor variations in recurring payment amounts; and
automatically approve recurring payments within defined thresholds.

6. The computer system of claim 1, wherein the payments module is further programmed to:
define different approval workflows based on payment type;
require multiple approvals for the transactions exceeding defined thresholds; and
implement escalation processes when approvers are unavailable.

7. The computer system of claim 1, wherein the payments module is further programmed to:
monitor transaction velocity;
identify unusual patterns in transaction frequency; and
limit further transactions when velocity thresholds are exceeded.

8. The computer system of claim 1, wherein the payments module is further programmed to:
integrate with third-party applications through application programming interfaces;
apply transaction controls within the third-party applications; and
share fraud detection data across integrated applications.

9. The computer system of claim 1, wherein the reporting module is further programmed to:
maintain an audit trail of transactions and the communications;
track approval workflows and decisions; and
generate reports of suspicious activity patterns.

10. The computer system of claim 1, wherein the payments module is further programmed to:
preauthorize transactions for specific events;
define spending limits by category and time period; and
implement time-based restrictions on certain transaction types.

11. A method of calculating a fraud score for financial transactions of a vulnerable adult, comprising:
analyzing transaction data using artificial intelligence to calculate the fraud score based on recipient information;
routing transactions for approval based on the fraud score; and
generating alerts when the fraud score meets or exceeds defined thresholds.

12. The method of claim 11, further comprising:
analyzing patterns across payment types, amounts, and frequencies using machine learning classification models trained on historical transaction data; and
detecting unusual patterns in recurring payment behaviors.

13. The method of claim 12, further comprising:
processing natural language content of messages and communications for fraud indicators;
evaluating similarity between current messages and known fraudulent communication patterns; and
analyzing context information provided by the vulnerable adult explaining transactions.

14. The method of claim 13, further comprising:
identifying relationships between transaction parameters using pattern recognition networks;
comparing current activity against historical baseline patterns for the vulnerable adult; and
maintaining a database of known fraudulent activities including websites, phone numbers, email addresses, and IP addresses associated with scams.

15. The method of claim 11, further comprising:
monitoring for deviations from normal transaction patterns using anomaly detection systems;
flagging unusual payment amounts, frequencies, or recipients; and
identifying suspicious changes in recurring payment behaviors.

16. The method of claim 11, further comprising:
applying different risk thresholds for various payment types;
automating escalation processes when suspicious patterns are detected; and
routing the transactions through appropriate approval workflows.

17. The method of claim 16, further comprising:
processing multiple data points simultaneously using neural networks to:
calculate comprehensive fraud scores;
learn and adapt to new fraud patterns over time; and
integrate fraud detection data from multiple third-party applications.

18. The method of claim 17, further comprising:
maintaining an audit trail of system decisions;
tracking effectiveness of fraud detection across different artificial intelligence components; and
updating artificial intelligence models based on confirmed fraudulent activities.

19. The method of claim 11, further comprising:
preauthorizing transactions for specific events by:
defining approved dollar amounts for specific locations and merchants;
setting date ranges for expected transactions; and
automatically approving the expected transactions that match predefined event parameters for travel, gifts, and other planned expenses.

20. The method of claim 19, further comprising:
implementing time-based transaction controls by:
defining exclusion periods for specific transaction types;
limiting transactions based on time of day and day of week;
adjusting approval thresholds for seasonal payment variations; and
modifying transaction limits based on recurring payment patterns for utilities and medications.
